(19) United States
(12) Patent Application Publication
(10) Pub. No.: US 2011/0063836 A1
(43) Pub. Date: Mar. 17, 2011

(54) SUPPORT STRUCTURE FOR A PLURALITY OF LENSES, LENS, LENS SYSTEM, AND OPTICAL SYSTEM

(75) Inventor: Markus SALM, Heusweiler (DE)

(73) Assignee: GLP GERMAN LIGHT PRODUCTS GMBH, Karlsbad (DE)

(21) Appl. No.: 12/879,239

(22) Filed: Sep. 10, 2010

(30) Foreign Application Priority Data
Sep. 11, 2009 (EP) 09011675.7

(51) Int. Cl. F21V 7/00; G02B 7/02

(52) U.S. Cl. 362/235; 359/811

(57) ABSTRACT

Embodiments show a support structure for a plurality of lenses having a support plate; and a plurality of adjacent hexagonal portions on the support plate, wherein a central opening penetrating the support plate is provided in each of the hexagonal portions, and wherein the support plate respectively comprises, at the vertices of the adjacent hexagonal portions, recesses for receiving a securing pin of a lens.

### CROSS-REFERENCE TO RELATED APPLICATIONS

This application claims priority from European Patent Application No. 09011675.7, which was filed on Sep. 11, 2009, and is incorporated herein in its entirety by reference.

### BACKGROUND OF THE INVENTION

The present invention relates to a support structure for a plurality of lenses, to a lens, to a lens system and to an optical system. In particular, the present invention relates to an optical system having a lens array with a plurality of light emitting diodes (LEDs) in red green blue (RGB) mixture, a total internal reflector (TIR) and a support with lenses, such as plano-convex lenses enabling a zoom function of the light beam by forward and backward motion. The optical system can, for example, be a spotlight or so-called moving head as they are used, for example, for illumination in stage technique or in events of all different types.

A known approach for producing a lens array is to injection-mold a large lens array, which has, however, the following disadvantages:
Significant tool costs, since the whole very large array is one lens and hence the complete injection-molding tool has to be polished according to optical standards.
It is not possible to produce the complete array with maximum transmission, since PMMA (polymethyl methacrylate) cools down during the injection process, which results in streaks in the plastic having a very negative effect on the optical performance.
PMMA is relatively dimensionally stable, however, it cannot be used very well for the production of large and flat components like respective high-performance plastics.
The array can only be used for one type of device. For devices with another number of lenses a new injection tool is necessitated.

### SUMMARY

According to an embodiment, a support structure for a plurality of lenses may have a support plate and a plurality of adjacent hexagonal portions on the support plate, wherein a central opening penetrating the support plate is provided in each of the hexagonal portions, and wherein the support plate respectively has, at the vertices of the adjacent hexagonal portions, recesses for receiving a securing pin of a lens.

According to an embodiment, the recesses at the vertices can penetrate the support plate.

According to another embodiment, a lens for assembly in a support system may have: a lens body, a first securing pin arranged at a first position on the lens body and extending in a first direction from the lens body, and a second securing pin arranged at a second position on the lens body and extending in the first direction.

According to an embodiment, the lens body comprises a first planar main surface and a curved second main surface opposing the first main surface, and the first and second securing pins extend perpendicular to the first main surface.

According to an embodiment, the lens body comprises a first curved main surface and a curved second main surface opposing the first main surface, wherein the first and second securing pins extend perpendicular to the first main surface.

According to embodiments, the lens body defines a plano-convex lens, a biconvex lens, a concavo-convex lens, a biconcave lens, a plano-concave lens or, for example, also a convexo-concave lens. The lens body can be formed as collecting lens or as diverging lens.

According to an embodiment, the first position where the first securing pin is arranged and the second position where the second securing pin is arranged are arranged diametrically opposed on the lens body.

According to another embodiment of the present invention, a lens system may have the inventive support system and a plurality of inventive lenses, wherein the securing pins of the lenses are received in the recesses of the support plate of the support system.

According to another embodiment of the present invention, an optical system may have an array of light sources and the inventive lens system.

According to the embodiment, the lens system is arranged moveably with respect to the array of light sources in order to provide a zoom function for the light beam that can be generated by the light sources.

According to an embodiment, the optical system further comprises a reflector arranged between the array of light sources and the lens system.

According to an embodiment, the optical system further comprises a reflector arranged between the array of light sources and the lens system.

According to a further embodiment, the optical system can alternatively also have a normal ellipsoid of rotation, a parabolic minor or a CPC (CPC=Compound Parabolic Concentrator) or an aspheric lens.

According to a further embodiment of the present invention, the optical system can comprise a further lens group apart from a reflector, such as the TIR reflector, the ellipsoid of rotation, the CPC element or an aspheric lens. This lens group can be arranged, for example, between the inventive lens system and the reflector or the above stated alternatives in the optical path of the optical system. A further lens group can further improve the light beam quality of the optical system.

According to an embodiment, the array of light sources comprises a plurality of light emitting diodes (LEDs, e.g., 120 LEDs) in a red green blue (RGB) mixture. In this embodiment, the lens system comprises plano-convex lenses and the reflector is implemented, for example, as a TIR reflector. As has been explained above, it is also possible that instead of such a reflector, a normal ellipsoid of rotation or CPC is used.

The invention allows that the lenses, e.g., the plano-convex or biconvex lenses are positioned as densely as possible, which ensures homogenous appearance and a compact device.

The invention relates also to the mechanical implementation of the lens assembly, such that
a maximum packing density can be obtained (lenses touch tangentially without any gap in-between),
the individual lenses are flexible enough during application so that they can also be used in other devices, e.g., with more or less lenses or so-called “striplites”,
the lenses can be mounted without adhesive, e.g. on the support plate,
a cost-effective injection tool can be used due to the restriction to individual lenses.

In this regard, the following basic considerations have been made:
When an array of round lenses is arranged such that every lens touches its adjacent lens, a hexagonal basic structure is obtained.
Since the complete aperture of the lens is to be used for the optical path, merely the “gaps” in the hexagonal grid are available for assembly.
The optical path striking the lenses is divergent. Hence, the openings in the support plate can be conical. This means the openings can be larger on the side facing the lenses than on the side facing away from the lenses.

The last aspect is useful for being able to produce a support holding the lenses. If every lens had a hexagonal flange and were adhered with an adhesive, the lens array would basically be finished. This would, however, have disadvantages, namely:
The cost for producing a lens array could be increased since the adhesive causes expenses.
The adhesive joint could develop cracks over time and even fall off after long operation due to the UV strain and the different coefficients of thermal expansion of the materials. This could be avoided by a slightly flexible adhesion. This, however, is in contrary to the request for a precisely positioned lens.
The correct positioning of the lenses before the openings in the support would have to be ensured by an external tool by fixing during the adhesive process.
Curing the adhesive is a significant time factor in mass production: applying adhesive—inserting the lenses—fixing—waiting until the adhesive has cured—further processing. This can again result in increased production costs compared to production without using adhesives.

The finding of fast and cost effective insertion underlying the invention is to injection-mold a peg to the lenses (with quasi hexagonal flange) at two opposing sides that is plugged through small openings in the support. The peg can be secured on the rear side by any method (resilient security ring, heat staking, ultrasound bonding). The two latter methods have the advantage that the process can run automatically and can also be monitored for quality automatically.

There are no running costs for consumables such as adhesive, and the finished device can be processed further immediately after the last welding process without having to wait for the adhesive to cure.

Further, the lenses have overlappings on one side (similar to roofing tiles), such that the same can hold each other.

Due to the pins (pegs) the lenses can be positioned very easily during insertion without necessitating time and cost intensive adjustment.

This method practically leaves all material options for producing the lens support. Options are black high-performance structural plastic (e.g., PPS GF40) that at the same time also takes on a shielding function, milled aluminum (stable), injected magnesium alloys (light) or even ceramic supports (for external stability).

It is another advantage that the individual components can be separated from each other easily during recycling and can then be separately supplied to recycling.

### BRIEF DESCRIPTION OF THE DRAWINGS

Embodiments of the present invention will be detailed subsequently referring to the appended drawings, in which:

FIG. 1 is an isometric top view of a support system for a lens system according to the present invention having a plano-convex lens removed from the support system with securing pegs arranged at opposing positions;

FIG. 2 is an isometric top view of a lens system according to the present invention with support system and a plurality of plano-convex lenses;

FIG. 3(a) is a top view of a lens system of FIG. 2 cut along a line;

FIG. 3(b) is a sectional view of the lens system of FIG. 3(b);

FIG. 4 is an isometric top view of three lenses according to an embodiment of the invention with securing pegs arranged at opposing positions, wherein the lens bodies have a quasi hexagonal flange that surrounds the central lens portion and on which the securing pegs are arranged;

FIG. 5 is a top view of the three lenses of FIG. 4 whose relative assembly with respect to each other shows when the same are arranged in the support system;

FIG. 6 is an enlarged isometric top view of a section of the lens system of FIG. 1 where the lenses of FIG. 4 are arranged; and

FIG. 7 is the section of FIG. 6 wherein a part of the lenses is removed from the support system, such that the support plate and the hexagonal portions are visible, as well as the central opening for the light passage and the smaller recesses for receiving the securing pegs of the lenses.

FIG. 8 is a schematic illustration of an optical system having the inventive lens system as well as an array of light sources;

FIG. 9 is a schematic illustration of an optical system, wherein the lens system is arranged moveably with respect to the array of light sources and wherein, alternatively, a second and/or third lens group is arranged schematically in the optical path of the optical system.

### DETAILED DESCRIPTION OF THE INVENTION

With respect to the following description of the embodiments of the present invention, it should be noted that the same reference numbers are used throughout the description in the different figures for functionally identical or equal or functionally equivalent elements or steps for simplification reasons.

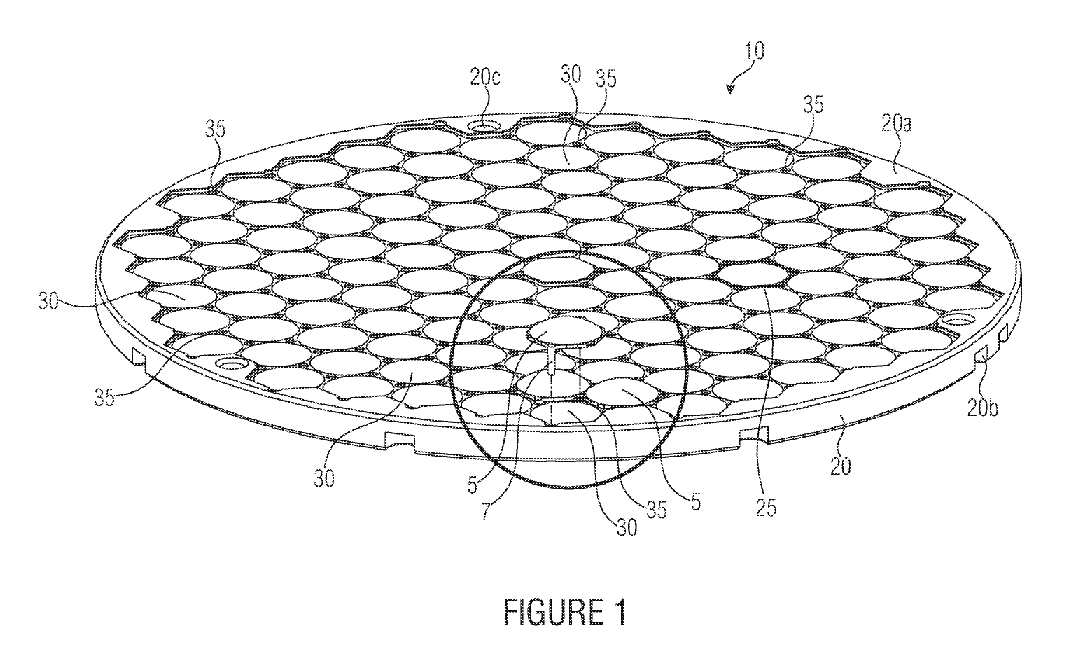

FIG. 1 illustrates in a perspective view a support structure or a support system 10 for a plurality of lenses 5 according to an embodiment of the present invention. The support structure 10 has a support plate 20 and a plurality of adjacent hexagonal portions 25 on the support plate 20. Each of the hexagonal portions 25 has a central opening 30. The hexagonal portions 25 form ridges that are formed in the shape of honeycombs. Each of the hexagonal portions has a central circular opening whose diameter can be larger than the width of the ridges of the hexagonal portions 25. The vertices or the corners of the adjacent hexagonal portions 25 can each have recesses 35. These recesses can be implemented such that they can receive a securing pin 7 of a lens 5 to be mounted on the support structure. This means the lenses 5 can be plugged into the respective recesses or bores 35 with the help of the securing pins 7.

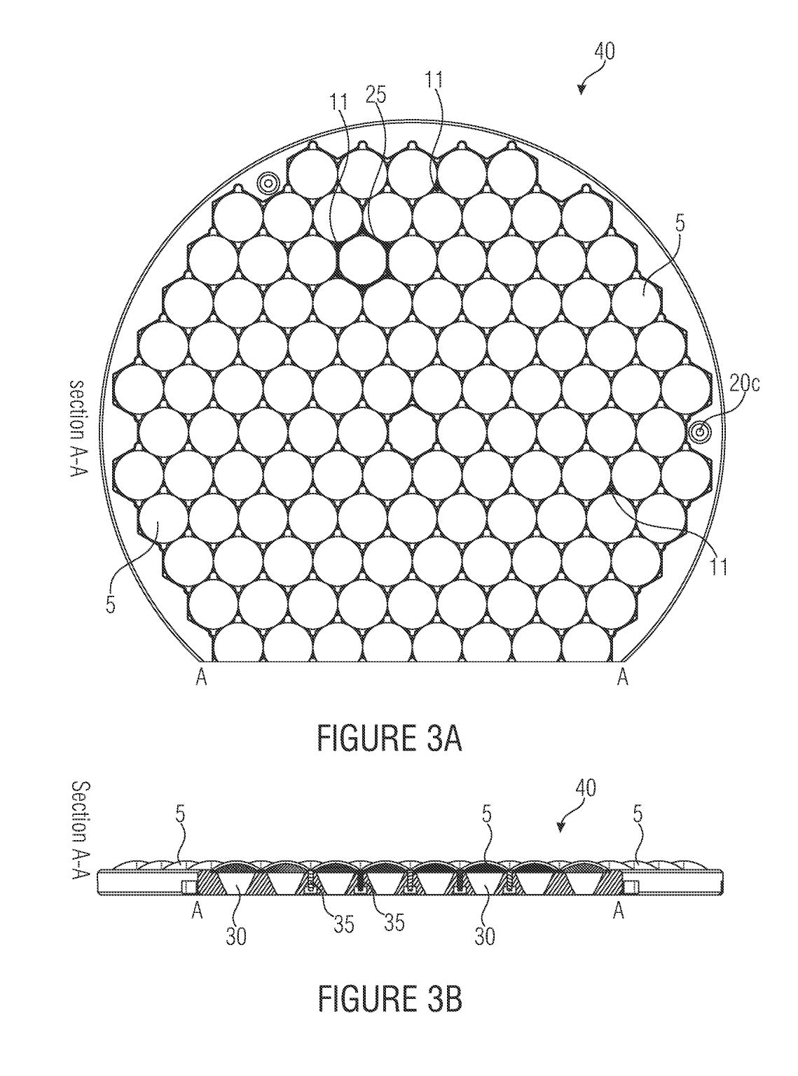

As illustrated in FIG. 1, the support structure 10 can have, for example, a round, oval or square shape and can be implemented in the shape of a disc. The shape of the support structure for a lens system can be implemented such that the lens system can be inserted, for example, in a correspondingly formed housing of a spotlight. The upper edge regions 20a of the support plate 20 can be slightly higher compared to the lower hexagonal portions 25 of the support plate 20. These hexagonal portions can, for example, be milled out of an aluminum support plate 20. The difference in height between the hexagonal portions 25 and the edge regions 28 of the support plate can be in the range of the thickness of the lens body 15 of the lens 5, wherein, as shown in FIG. 3b, the lenses 5 can still protrude beyond the upper edge of the support plate 20.

The support structure 10 for producing the lens system can be implemented of a plurality of materials. For example, metals such as aluminum, or plastics, such as the high-performance structural plastic PPS-GF 40, which can at the same time also take on a shielding function, can be used. The support structure 10 can, for example, also consist of (injected) magnesium alloys, which are advantageously very light, and even of ceramic supports having very high stability.

As can be seen in FIG. 1, due to the “mosaic-like” structure with the hexagonal portions 25, identical lenses 5 can be used advantageously in differently sized or dimensioned support structures 10 having different shapes. If, for example, a support structure 10 has a smaller diameter, correspondingly fewer hexagonal portions 25 will be on the support plate 20 for receiving lenses 5 and, accordingly, fewer lenses 5 will be mounted on the support plate 20. Hence, the inventive support system for a plurality of lenses can provide a lens array for lens systems having different shapes and dimensions in a simple manner. Vice versa, obviously, the dimensions of the hexagonal portions 25 can also be changed, i.e., lenses 5 having respectively larger or smaller dimensions can be used.

The inventive lens system of support structure or support system 10 and the plurality of lenses 5 can be inserted, for example, in an optical system, such as a spotlight or a so-called moving head for illumination purposes. The support plate can have, in a lateral edge region 20b, recesses for mechanically holding or mounting the support structure in a housing of a spotlight. Further, the support structure 10 can have vias or holes 20c for mechanically guiding or holding the support structure 10 on its surface in the edge region 20a.

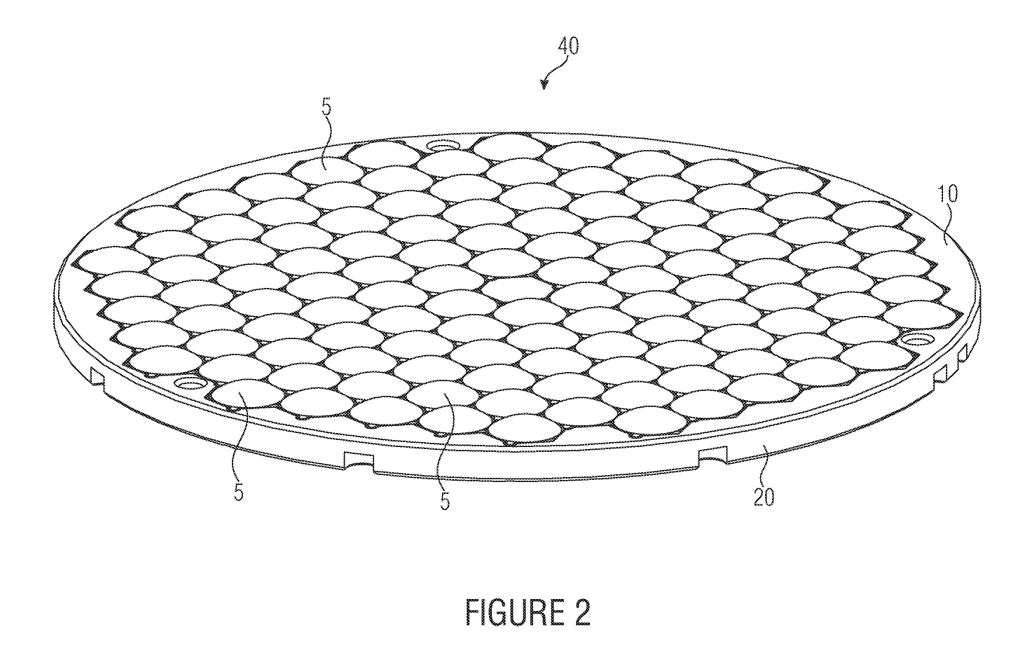

FIG. 2 shows the isometric top view of a lens system 40 having a support system 10 as described in the context of FIG. 1 and the plurality of lenses 5 arranged thereon. The individual lenses 5 are inserted into the support structure 10 with the help of their respective securing pins. Together, the individual lenses 5 form a lens array adapted in size and dimension to the size and dimension of the support structure 10.

FIG. 3a shows a top view of the lens system 40 cut along a line A-A. In embodiments, the lens array formed of the plurality of individual lenses 5 is structured such that the individual lenses 5 have a maximum packing density within the support structure 10. This means that the lenses touch each other tangentially, without any gap in-between. When using round lenses that are to obtain the maximum packing density, every lens touches its adjacent lens. This results in a hexagonal basic structure as can be seen in the top view of FIG. 3a that corresponds, in its basic form, to the adjacent hexagonal portions 25 on the support plate 20 in FIG. 1. Since the whole aperture of every individual lens of the lens array is possibly to be used completely for the optical path, merely the “gaps” 11 resulting between the adjacent round lens bodies 50 at the respective corners of the hexagon or the hexagonal portions are available for mounting the lenses 5 on the support structure 10.

FIG. 3b shows the side view of the section A-A of the lens system of FIG. 3a. In this embodiment, the central openings 30 in the support plate 10 are formed in the shape of a truncated cone. This means on the side facing the lenses or the upper side 20d of the support plate 10, the central openings 30 are larger in cross section than on the side facing away from the lenses or the underside 20b of the support plate.

Further, the recesses 35 are illustrated in the “gaps” in the hexagonal grid for mounting the lenses 5. These recesses 35 are implemented to receive the securing pins of the lenses 5.

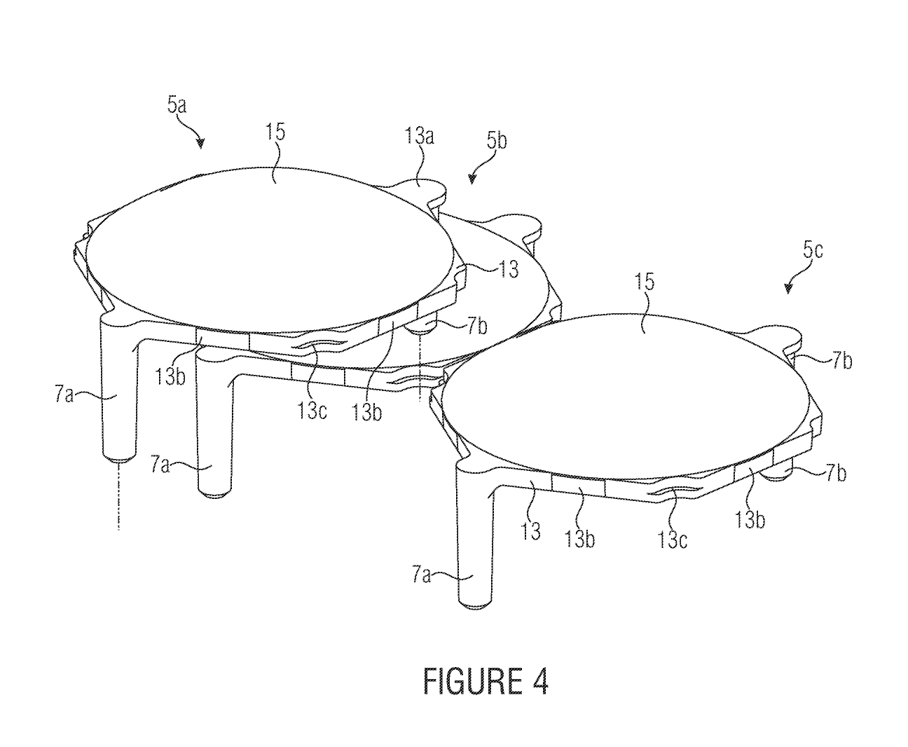

An embodiment of the inventive lenses 5 is illustrated in the symmetrical top view of FIG. 4. FIG. 4 shows three lenses 5a-c according to an embodiment of the invention with securing pegs arranged at opposing positions. The lens 5a has a lens body 15 as well as two securing pegs 7a, 7b arranged at opposing positions. The lens body 15 is formed as optical lens for optical mapping. Correspondingly, the lens body can be implemented, for example, as biconvex lens, plano-convex lens, concavo-convex lens, biconcave lens, plano-concave lens or convexo-concave lens. The lens body 15 can also be a spherical lens or also an aspherical lens.

Further, the lens 5 comprises a quasi hexagonal flange or edge 13 surrounding the central lens body or lens portion 15 and connected with securing pegs 7a, 7b. Every edge 13 has, contact regions 13b at the six sides that are flush with the adjacent lens in a maximally densely packed lens system or lens array. This means adjacent lenses touch tangentially in the lens system without any gap in-between at the contact regions 13b. Thereby, a maximum packing density of the lenses can be obtained and, hence, potential light losses of a light beam passing through the lens system can be minimized. The flange or the lens edge 13 further comprises recesses 13c that are implemented such that an overlapping 13a of another lens can each be inserted into the recesses 13c of two other lenses during lens assembly, such the individual lenses overlap in a similar manner as in roofing tiles and hence can mechanically hold or stabilize each other. As shown in this embodiment, the overlapping 13a can be implemented above the securing peg 7b of a lens. Obviously, assembly of the lenses without overlapping or by means of a differently formed overlapping is also possible.

By the pins or pegs 7, the lenses 5 can be positioned very easily and mounted very quickly during population of a support structure, without necessitating time or cost intensive adjustment of the individual lenses. The lenses 5 are actually only plugged into the recesses 35 with their securing pins. The pegs or securing pins 7 can be injection-molded to the lens body 15. The pegs or securing pins can be secured by different methods such as the usage of resilient security rings, by means of heat staking or ultrasound bonding. This means the securing pins can be mounted in a manifold and easy manner in the recesses 35. There are no running costs for consumables such as adhesive, and the finished device can be processed further immediately after the last welding process without having to wait for the adhesive to cure.

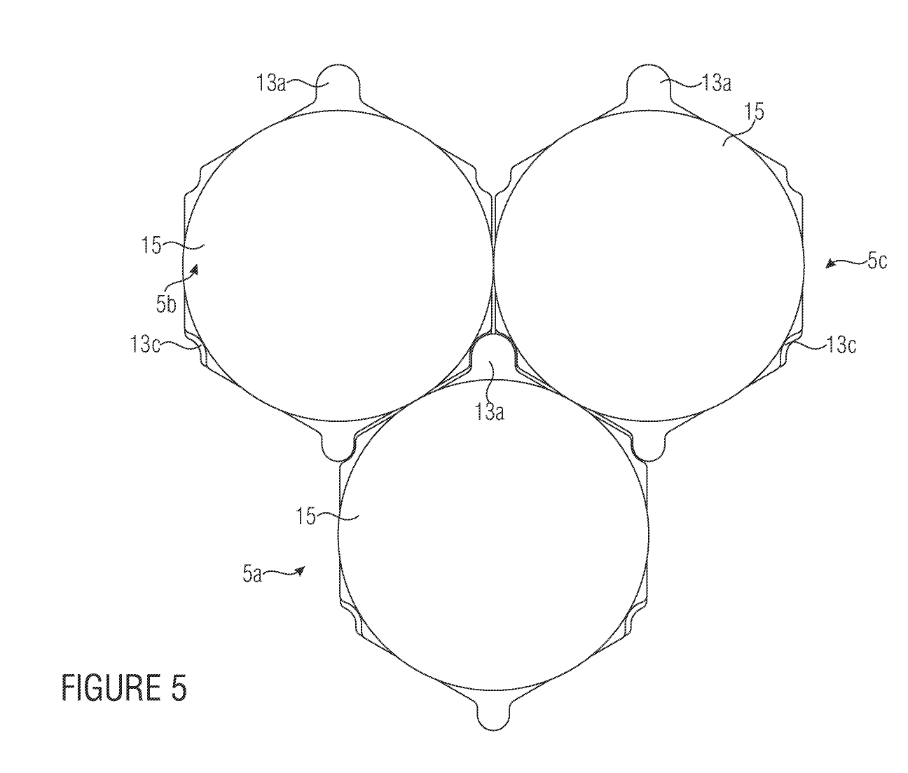

FIG. 5 shows the top view of the three lenses 5a-c of FIG. 4 and their assembly in relation to each other when the same are arranged in the support system. As can be seen very well from this figure, the overlapping 13a of the lens 5a mechanically stabilizes the two lenses 5b and 5c by arranging the overlapping 13a in the respective recesses 13c of lenses 5b and 5c.

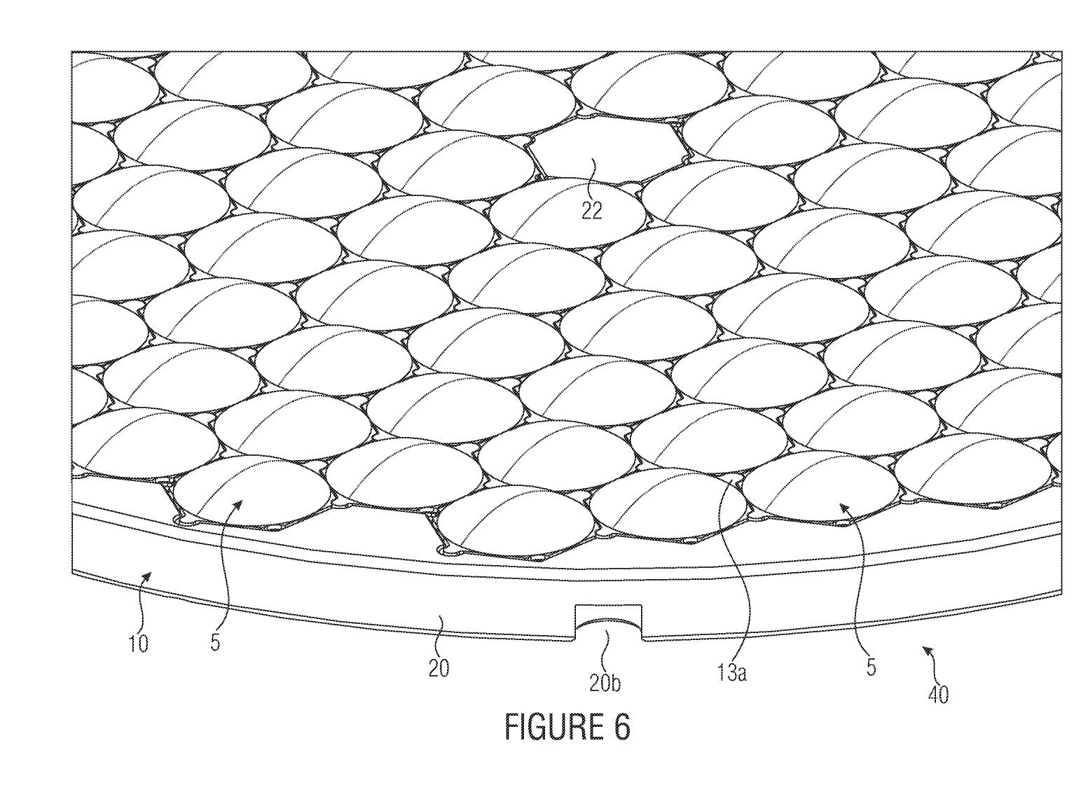

FIG. 6 shows an enlarged isometrical top view of a section of a lens system 40, where a plurality of lenses 5 are arranged on a support plate 20. The individual overlappings 13a of lenses 5 mechanically stabilize the respective lenses arranged in front of them, similar to roofing tiles. The hexagonal basic structure of the lens array can be seen due to the missing lens 22 in FIG. 6.

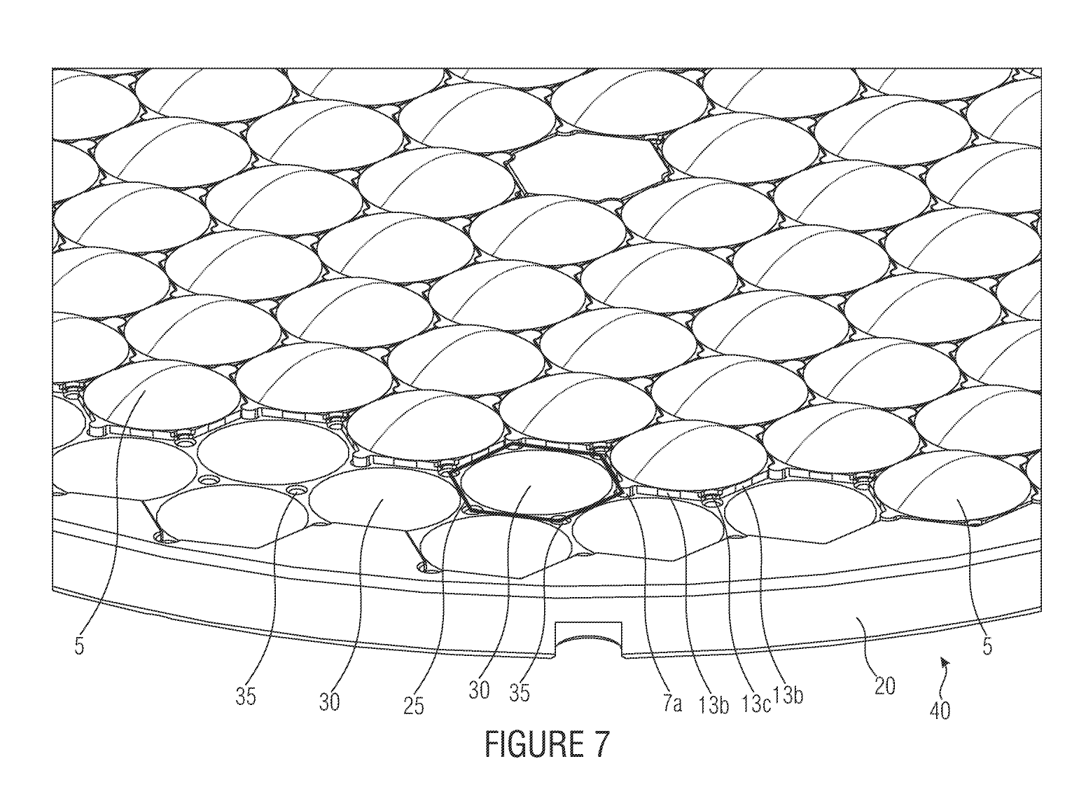

FIG. 7 also shows the enlarged isometrical top view of FIG. 6, wherein in this figure part of the lenses 5 has been removed from the support system, such that the support plate 20 with the hexagonal portions 25 as well as the central openings 30 for the light passage can be seen. Further, the smaller recesses 35 for receiving the securing pegs 7 of lenses 5 are illustrated. A lens 5 comprises the lens body 15 already mentioned above as well as a first securing peg 7a and a second securing peg 7b with the overlapping 13a already mentioned above. The lens 5 has an edge or flange 13 with respective recesses 13c for receiving an overlapping 13a of a different lens 5 as well as the tangential planar areas 13b ensuring that the lenses can abut on each other in this region without any gap in-between and, hence, maximum packing density of lenses is enabled.

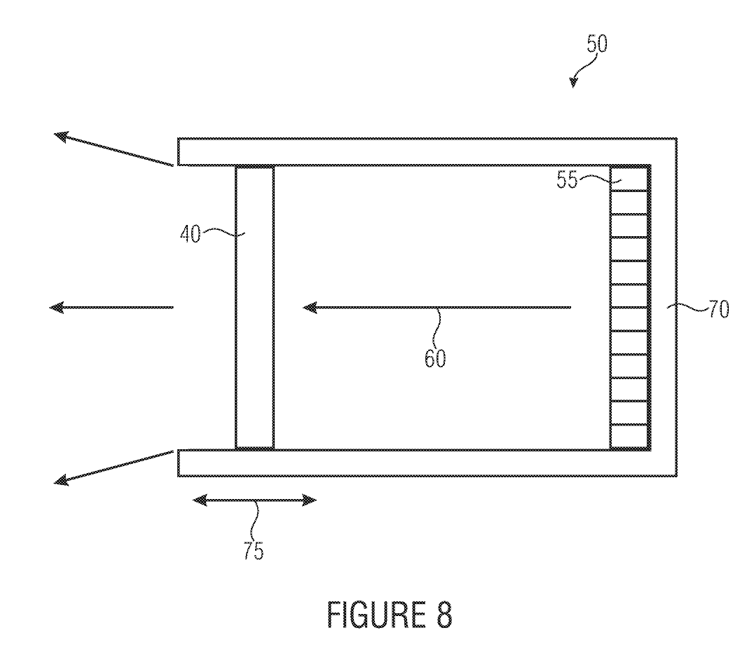

FIG. 8 shows the schematic illustration of an inventive optical system 50 having an array of light sources 55 in a lens system 40 as already described above. The optical system 50 can, for example, be a spotlight. The optical system 50 comprising an array of light sources 55 in the lens system 40 can be inserted in a housing 70. According to an embodiment, the lens system 40 can be arranged moveably 75 with respect to the array of light sources 55. This means the lens system can be moved towards or away from the array of light sources. This can realize a zoom function for the light radiation 60 emitted from the light sources 55. It is also possible that the array of light sources 55 is arranged in a movable manner with respect to a firmly placed lens system 40.

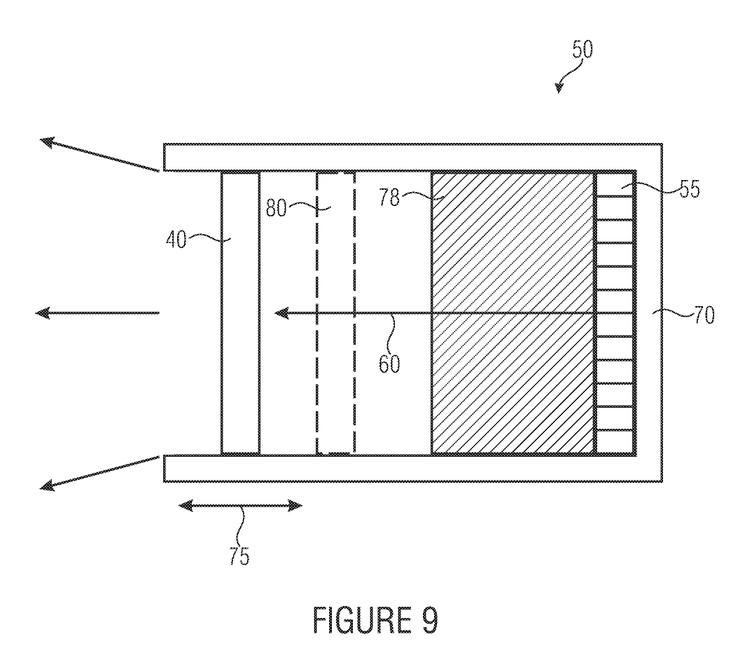

As shown schematically in FIG. 9, according to an embodiment of the present invention, at least one reflector 78, e.g., a TIR reflector can lay between the array of light sources 55 and the lens system 40. By using such a reflector, light efficiency as well as the quality of the light beam 60 can be improved. In further embodiments of the present invention, in a system 50 a further lens group 80 can be arranged. This lens group 80 can, for example, be a negative lens, which means a diverging lens, this can further improve the quality of the light beam 60. According to further embodiments of the present invention, instead of a TIR reflector 78, an ellipsoid of rotation or, as described above, a compound parabolic concentrator (CPC or parabolic mirror) or an aspheric lens can be used.

The array of light sources 55 can, for example, be an array of light emitting diodes (LEDs). The light emitting diodes can have different emission spectrums, such as in the red, green, yellow and blue spectral range, and with a respective mixture, they can emit a mixed white light spectrum. This means the array of light sources 55 can be LEDs in a RGB mixture. The optical system 50 can have a respective current voltage supply and a respective control of the light sources not shown in FIGS. 8 and 9. By a respective control of the LEDs, all colors in the visible spectral range can be generated. The optical system 50 can be a spotlight or a moving head, such as it is used, for example, for illuminating stages, buildings, for film and television or for other events or in discotheques. The number of individual light sources of the array of light sources 55 can correspond to the number of individual lenses 5 of the lens system 40 or can at least be correlated to the same.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1-14. (canceled)

15. Support structure for a plurality of lenses, comprising:
a support plate; and
a plurality of adjacent hexagonal portions on the support plate,
wherein a central opening penetrating the support plate is provided in each of the hexagonal portions, and
wherein the support plate respectively comprises, at the vertices of the adjacent hexagonal portions, recesses for receiving a securing pin of a lens.

16. Support structure according to claim 15, wherein the recesses at the vertices penetrate the support plate.

17. Lens for assembly in a support system, comprising:
a lens body;
a first securing pin arranged at a first position on the lens body and extending in a first direction from the lens body; and
a second securing pin arranged at a second position on the lens body and extending in the first direction.

18. Lens according to claim 17, wherein the lens body comprises a first planar main surface and a curved second main surface opposing the first main surface, and wherein the first and second securing pins extend perpendicular to the first main surface.

19. Lens according to claim 17, wherein the first position where the first securing pin is arranged, and the second position where the second securing pin is arranged are arranged diametrically opposite on the lens body.

20. Lens according to claim 17, wherein the lens body defines a biconvex lens, a plano-convex lens, a concavo-convex lens, a biconcave lens, a plano-concave lens or a convexo-concave lens.

21. Lens according to claim 17, wherein the lens comprises an edge comprising an overlapping and a recess, wherein the overlapping is implemented to fit at least partly into a recess of a second lens, and wherein the recess is implemented to receive at least partly the overlapping of a third lens.

22. Lens system, comprising:
a support system for a plurality of lenses, comprising:
a support plate; and
a plurality of adjacent hexagonal portions on the support plate,
wherein a central opening penetrating the support plate is provided in each of the hexagonal portions, and
wherein the support plate respectively comprises, at the vertices of the adjacent hexagonal portions, recesses for receiving a securing pin of a lens; and
a plurality of lenses for assembly in a support system, comprising:
a lens body;
a first securing pin arranged at a first position on the lens body and extending in a first direction from the lens body; and
a second securing pin arranged at a second position on the lens body and extending in the first direction,
wherein the securing pins of the lenses are received in the recesses of the support plate of the support system.

23. Optical system, comprising:
an array of light sources; and
a lens system, comprising:
a support system for a plurality of lenses, comprising:
a support plate; and
a plurality of adjacent hexagonal portions on the support plate,
wherein a central opening penetrating the support plate is provided in each of the hexagonal portions, and
wherein the support plate respectively comprises, at the vertices of the adjacent hexagonal portions, recesses for receiving a securing pin of a lens; and
a plurality of lenses for assembly in a support system, comprising:
a lens body;
a first securing pin arranged at a first position on the lens body and extending in a first direction from the lens body; and
a second securing pin arranged at a second position on the lens body and extending in the first direction,
wherein the securing pins of the lenses are received in the recesses of the support plate of the support system.

24. Optical system according to claim 23, wherein the lens system is arranged movably with respect to the array of light sources in order to provide a zoom function.

25. Optical system according to claim 23 comprising a reflector arranged between the array of light sources and the lens system.

26. Optical system according to claim 24, wherein the array of light sources comprises a plurality of light emitting diodes (LEDs) in a red green blue (RGB) mixture, wherein the lens system comprises plano-convex lenses and wherein the reflector is a total internal reflector (TIR).

27. Optical system according to claim 25, wherein the reflector is implemented as TIR reflector, as ellipsoid of rotation or as parabolic mirror (CPC=Compound Parabolic Concentrator).

28. Optical system according to claim 23, further comprising a further lens group implemented as negative lens and arranged between the lens system and the array of light sources.
